(19) United States
(12) Patent Application Publication
(10) Pub. No.: US 2013/0086774 A1
(43) Pub. Date: Apr. 11, 2013

(54) DEVICE TO HOLD TWO HANDBAG OR PURSE HANDLES TOGETHER

(71) Applicants: Charlotte R. Krasinski, North Port, FL (US); Raymond H. Krasinski, North Port, FL (US)

(72) Inventors: Charlotte R. Krasinski, North Port, FL (US); Raymond H. Krasinski, North Port, FL (US)

(21) Appl. No.: 13/633,694

(22) Filed: Oct. 2, 2012

Related U.S. Application Data
(60) Provisional application No. 61/543,590, filed on Oct. 5, 2011.

(51) Int. Cl. B65D 63/10; B65D 63/00; B23P 11/00

(52) U.S. Cl. 24/16 R; 29/428

(57) ABSTRACT

A device for holding two handles of a purse or handbag together includes an inner retaining strap and outer retaining strap. The straps are made of thin flexible material. The straps are attached at or near their respective longitudinal centers providing free movement of the longitudinal ends. A closure such as a hook and loop material is at the ends of straps allow the formation of the straps into closable and releasable loops. The outer strap is longer than the inner retaining strap. The outer retaining strap has a weight that can be in the form of a decorative element on the outside face at one longitudinal end, or can be incorporated into or on the end, or comprise the closure, and facilitates closing and opening the device. Alternatively, the closure of at least the outer strap can be a mechanical snap, magnetic, or other suitable construction.

This application claims the benefit of provisional patent application No. 61/543,590, filed on 2011 Oct. 5 by the present inventors, which is incorporated in its entirety by reference.

### TECHNICAL FIELD

This invention relates generally to a device for holding handles or straps of a handbag or purse together, and more particularly, that is easily and conveniently releasable with a predetermined simple, convenient motion to allow access to the handbag or purse interior, is re-engageable for again holding the handles or straps together with another predetermined, simple and convenient motion, and which is retained on one of the handles or straps so as to stay with the handbag or purse whether carried on the shoulder or elsewhere. The releasing action and reengaging action are facilitated by a weight element on the end of a retaining strap of the device.

### BACKGROUND ART

The following is a tabulation of some prior art that appears relevant:

| Pat. | | | |
|---|---|---|---|
| No. | Kind Code | Issue Date | Patentee |
| 546,920 | None | September | Freund |
| | | 1895 | |
| 714,538 | None | November 1902 | Walter |
| 1,027,527 | None | May 1912 | Davis |
| 2,079,045 | None | May 1937 | Schlaepfer |
| 2,608,326 | None | August 1952 | Spector |
| 3,982,305 | None | September | Meyer |
| | | 1976 | |
| 4,062,065 | None | December 1977 | Gardner |
| 4,811,876 | None | March 1989 | Riggi |
| 4,911,347 | None | March 1990 | Wilhite |
| 5,307,966 | A | May 1994 | Inaba, et al |
| 5,307,967 | A | May 1994 | Seals |
| 5,441,188 | A | August 1995 | Rosenstein |
| 5,666,701 | A | September | Drummond |
| | | 1997 | |
| 6,606,768 | B2 | August 2003 | Henry, et al |
| D573796 | S | July 2008 | Reynolds |
| D600592 | S | September | Dandu Rand |
| | | 2009 | |
| 7,788,772 | B2 | September | Dandu Rand |
| | | 2010 | |
| D607210 | S | January 2010 | Reynolds |
| D607211 | S | January 2010 | Reynolds |
| 7,725,958 | B1 | June 2010 | Gilmore |

### Foreign Patents

| Pat. No. | Kind Code | Issue Date | Patentee |
|---|---|---|---|
| WO2012023966 | A1 | February 2012 | Tumi, Inc. |
| WO2011093338 | | April 2011 | Irie |

### Nonpatent Literature Documents

EP1177740 Application withdrawn Jan. 1, 2012/Borgomanero, Gianpaolo {published on {May 1, 2005 [January 2005/]}

Ferund discloses an attachment that mounts to a belt or skirt. The device is designed to be rigid in composition and is not flexible. The device has the purpose of controlling a garment though attachment to the belt of skirt, not controlling purse or handbag handles.

Walter discloses an article that is used to hold a pencil or pen. The device consists of a small flexible loop attached to an apparatus that pins through the clothing. The loop is flexible, but enclosed and cannot be used to wrap around a strap. There is only a single loop and the drawback of the device having to attach to one's clothing to be of use.

Davis discloses a device to hold a cord of a shoulder bag to the shoulder of the wearer. The device operates by being pinned through the clothing and does not control the cord once removed from the shoulder.

Schlaepfer discloses a device that relates to apparel and particularly to a retaining means for resisting relative movement between two garments. Object is the provision of a garment retainer adapted to be inserted between a waist band and a shirt to prevent shirt from climbing up and is not relative to the straps of shoulder bags or purses.

Spector discloses a device in which the objective of invention is to prevent shoulder strap from slipping when positioned on a person's shoulder, as well as to cushion the weight of articles suspended form a person's shoulder by means of a supporting.

Meyer discloses a pin assembly for fastening to the exterior shoulder section of a garment for the detachable retention of a shoulder strap of a bag worn simultaneously with the garment. The device is goes through the clothing of the wearer and is rigid with a U shaped frame to the underside of which a pin is pivotally mounted between the legs of the U section.

Gardner discloses a pin type device used to hold a shoulder strap to the wearer's shoulder; however, there is a mechanism that allows the pin through the clothing to break away if suddenly pulled so as to not damage the clothing. The device is designed to hold a strap to a shoulder and is attached through the clothing.

Riggi discloses a device which is a retainer for positionally locating a shoulder strap of a handbag or the like relative to the shoulder of a user includes a base member carrying an adhesive for removably attaching the retainer to the skin on the shoulder of the user and a retainer member arranged to upstand from the base member and provide a recess for receiving the shoulder strap. This device uses glue to adhere to the wearer's shoulder and does not connect to the shoulder strap or remain with the shoulder bag if removed from the wearer's shoulder. If the shoulder strap of a bag is removed from the wearer's shoulder the device remains glued to the wearer shoulder.

Wilhite discloses a strap type carrier and locking seal for articulated drawing tubes and other cylindrical objects with slip on end caps of different diameters and lengths. Consists of two circumferential fastening members and adjustable longitudinal carrying strap. Members are cinched about the top and bottom of a tube and cylinder by wrapping the fastening members around the tube and extending the free end of the fastening members through a rectangular ring at the opposite end.

Seals, discloses a strapping structure for an optical instrument such as a camera a video camera a binocular and so on which is capable of performing as more than two straps having different functions such as a grip strap and a shoulder strap. Structure comprises a loop-shaped strap which is installed on the camera body and a stopper provided on an intermediate portion of the loop-shaped strap. The stopper is shiftable along a longitudinal direction of the strap and forms a large loop-shaped first strap serving for example as a shoulder strap and a small loop shaped second strap serving for example as a grip strap. This device is for length control of an optical device having a strap.

Rosenstein discloses a shoulder strap and jewelry retainer, removably attachable to the user's garment for support of ornamental jewelry attachments and for the retention of a shoulder strap so that a user may carry a sling or strap equipped article without lifting the shoulder while simultaneously preventing theft of the mentioned article. The shoulder strap and jewelry retainer may be attached to the user's garment by any conventional means and includes a releasable clip structure capable of capturing a shoulder strap. Ornamental jewelry is attached to the clip for disguising the clip structure and for accenting the user's clothing. This device is rigid, and does not stay attached to the purse or shoulder bag once removed from the wearer's shoulder.

Drummond discloses a device designed to hold the strap of a shoulder bag to the shoulder of the wearer. The shoulder strap retainer is used such that the shoulder strap is placed on top of the shoulder while the shoulder strap retainer is positioned underneath the arm and adjusted to securely fit the shoulder strap to the shoulder.

Henry, et al discloses a strap device for holding objects held by infants for preventing the object from falling to the ground if released by the infant.

Reynolds discloses a design patent for a rigid S type clip of plastic or similar material that clips via pin to an outer garment. It remains with the wearer's shoulder once the item with the strap is removed.

Dandu Rand discloses a rigid metal or plastic button style device which has a base that connects through the clothing and is used to stop a shoulder strap from slipping off the wearer. The device remains on the shoulder of the wearer if the handbag is removed.

Gilmore discloses a shoulder strap retainer designed to hold a shoulder strap on the shoulder of the wearer. The device is attached to the garment and when the purse or handbag is removed the device remains with the garment.

None of the devices discussed above provide the combination of capabilities and advantages sought, namely, a device that is retained on the handle or strap of a handbag or purse, holds the handles or straps securely together, yet allows releasing and separating one of the handles or straps from the other with a simple, convenient motion to allow opening the handbag or purse, and that allows again retaining the handles or straps together with another simple convenient motion, and which overcomes one or more of the shortcomings of the devices reviewed above.

### SUMMARY OF THE INVENTION

What is disclosed is a device which provides the combination of capabilities and advantages sought, namely, a device that is retained on the handle or strap of a handbag or purse, holds the handles or straps securely together, yet allows releasing and separating one of the handles or straps from the other with a simple, convenient motion to allow opening the handbag or purse, and that allows again retaining the handles or straps together with another simple convenient motion, and which overcomes one or more of the shortcomings of the devices reviewed above.

According to a preferred aspect of the invention, the device is comprised of two retaining straps, an inner retaining strap and an outer retaining strap. The retaining straps are made of a flexible material such as leather, vinyl, fiber, e.g., fabric, or similar material that is capable of being wrapped around a purse handle repeatedly without breaking or fracturing. According to one aspect of the present invention, a closure, comprising, for example, hook and loop material, a snap, or magnet, is attached at the end of each retaining strap as a mechanism or means for forming a closable and releasable loop with each retaining strap. The inner retaining strap and outer retaining strap are connected at or near the longitudinal center of each. The straps are arranged in a fashion that allows the outer retaining strap to form a loop completely around the inner retaining strap. The inner retaining strap is wrapped around one handle or strap, herein further referred to interchangeably by the term handle, of a purse or handbag and the closure is engaged creating a closed loop. The second handbag or purse handle is now brought alongside the first handle and the outer retaining strap is wrapped around both. Engaging the closure of the outer retaining strap provides a closed loop around both handles, holding them together. Releasing one of the purse handles is as simple as disengaging or releasing the closure of the outer retaining strap. To facilitate opening of the outer retaining strap, a charm or other element, preferably decorative, is attached to its end in a manner of a weight. The weight of the charm or similar decorative element is advantageous as it can help the outer retaining strap to open fast, to allow quickly accessing the purse or handbag while also providing a visually interesting element. Alternatively, the weight can be incorporated into or on the end of the strap and/or the closure, e.g., in a non-descript or concealed manner.

As an illustration, with the device properly oriented, by disengaging or releasing the outer closure the end of the outer strap with the weight on the end can fall by gravity, such that the now released handle is clear and can fall by gravity away from the other handle, to enable accessing the purse or handbag. This can be accomplished with a flipping or sweeping type movement in a direction for opening the closure, which allows the purse handles to be separately manipulated, particularly the now free handle to fall or be moved away from the other handle, while the inner retaining strap keeps the device attached to the other purse handle, so it does not require further handling and the device cannot be misplaced.

Similarly, with a single flipping or sweeping movement in the direction for closing the closure, the free handle can be brought together with the other handle, and the closure engaged.

### BRIEF DESCRIPTION OF THE DRAWINGS

In the drawings, closely related figures have the same number but different alphabetic suffixes.

FIG. 1A is the top view of the outer retaining strap.

FIG. 1B is the side view of the outer retaining strap.

FIG. 1C is the side view of the inner retaining strap.

FIG. 1D is the side view of the entire present invention.

FIG. 2 is a perspective view of the present invention showing the inner retaining strap in a closed position and the outer retaining strap in an in an open position.

FIG. 3 is a perspective view of the of the operation of closing the outer retaining strap.

FIG. 4 is a perspective view of the present invention in the fully closed position.

FIG. 5 is a perspective view of the operation of releasing the outer retaining strap.

FIG. 6 is a perspective view of alternative closure type with button snaps.

FIG. 7 is a perspective view of an alternative closure type with magnetic material.

### DRAWINGS-REFERENCE NUMERALS

1 Outer retaining Strap Assembly

2A Outer face of outer retaining strap

2B Inner face of outer retaining strap

3 Charm

4 Hook and loop material closure

5 Inner retaining strap Assembly

5A Inner face of inner retaining strap

5B Outer face of inner retaining strap

6 Snap closure

7 Magnetic closure

### DETAILED DESCRIPTION OF THE INVENTION

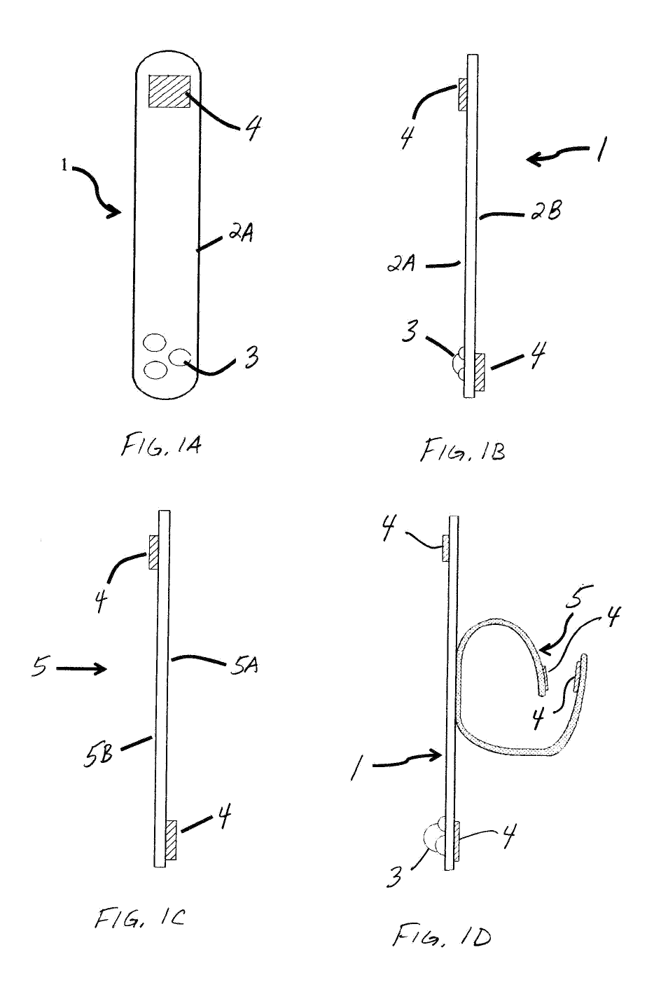

FIG. 1A is the top view of one embodiment of the outer retaining strap assembly 1. In FIG. 1A, the outer retaining strap 1, is a thin flexible strap of leather, vinyl, fabric or similar material that can be repeatedly bent and straightened out without fracturing. The outer retaining strap 1, has an outer face 2A (FIG. 1A). At one longitudinal end of the outer face 2A or the outer retaining strap 1, a decorative charm 3 is attached. In the present embodiment (FIG. 1A) the decorative charm 3, is a plastic and crystal decorative stud type charm. However, various types of charms of metal, plastic, fiber, e.g., fabric, mineral, gemstone, or other compositions are suitable to serve the decorative function. In FIG. 1A, a closure here comprising a section of hook and loop type material 4, is sewn, adhered, fused, or laminated to the outer face 2A of the outer retaining strap 1, opposite the longitudinal end with the attached charm 3. The hook and loop section 4 used as a closure is but one of several closures that can be used with the invention and is therefore non-limiting. Various alternative closure embodiments can include, but are not limited to, a snap closure mechanism or a magnetic closure, both commercially available.

FIG. 1B shows side view of the outer retaining strap 1. The outer retaining strap 1, which has an outer face 2A and an inner face 2B. On one longitudinal end of the outer face 2A is located the decorative charm 3, at the other longitudinal end of the outer face is the closure of hook and loop type material 4. In this embodiment there is a section of hook and loop type material 4 that is suitably affixed, e.g., sewn, adhered, fused, or laminated to the inner face 2B of the outer retaining strap. The outer retaining strap assembly typically has a thickness of ½ mm to several millimeters and has a length sufficient to wrap around two purse or handbag handles configured to be grasped with a normally formed human hand.

FIG. 1C depicts the side view of the inner retaining strap assembly 5, made from a thin flexible material such as leather, vinyl, fiber or fabric or other similar material that can be repeatedly bent and straightened out without fracturing. The inner retaining strap has an outer face 5A and an inner face 5B. In this embodiment, the inner retaining strap assembly has a closure comprising a section of hook and loop type material 4, suitably attached, e.g., sewn, adhered, fused, or laminated at one longitudinal end of the outer face 5A, and another section of hook and loop material 4, suitably attached to the inner face 5B of the opposing longitudinal end. Alternatively, the inner retaining strap can comprise a unitary strip of hook and loop material. The strap portion of the inner retaining strap assembly 5, is typically from ½ mm to several millimeters thick and has a length typically from 2″ to 8″, or otherwise sufficient to accommodate the circumference of a typical two handled purse or handbag handle configured to be grasped in a normally formed human hand. The width and length of the inner retaining strap assembly 5, is preferably narrower and shorter than the outer retaining strap assembly; therefore, when fully closed the inner retaining strap assembly is typically not visible as it is covered or occluded by the longer and wider outer retaining strap assembly.

FIG. 1D depicts the side view of one embodiment of the entire present invention. A portion of the inner retaining strap assembly 5, is attached by an attachment, e.g., sewn, fused, mechanically fastened, or laminated, to the outer retaining strap assembly 1. The attached portions of the inner and outer retaining strap are near the midsection of each strap and the attachment is configured in a manner to leave the two longitudinal ends of the each strap independent of one another as illustrated.

OPERATION—FIGS. 1B-D, 2, 3, 4, 5, 6, 7—Operation involves wrapping the inner retaining strap 5 (FIG. 1D) around one of the purse or handbag handles and securing it with the closure method, e.g., engaging the hook and loop material closure. The second purse or handbag handle is now brought alongside the first and the outer retaining strap 1 (FIG. 1D) is closed as a loop around both purse or handbag handles and secured by the closure of that strap, thus holding the handles together. A more detailed description of the operation follows:

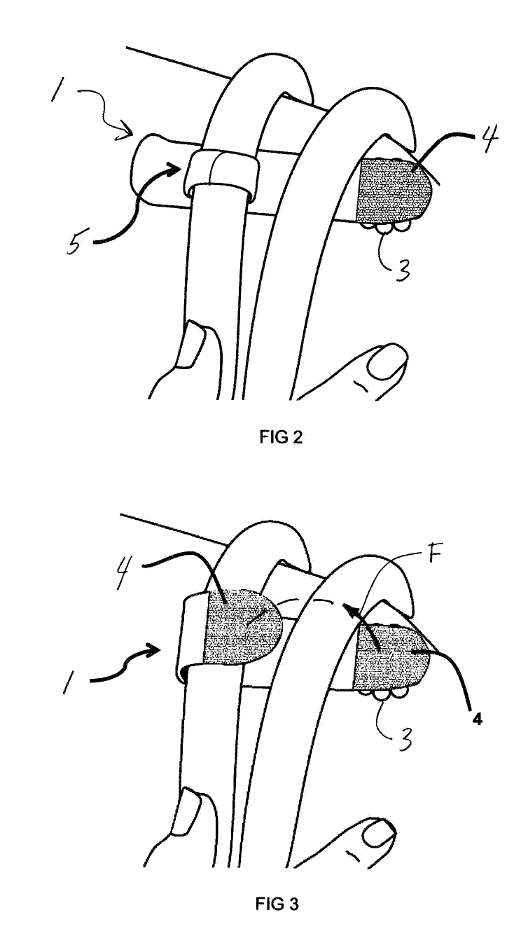

FIG. 2 shows a perspective view of the present invention attached to one handle of a purse prior to closure. To use the invention both the inner retaining strap and outer retaining strap are opened in a flaccid manner and in a position that is upside down or exposing the inner face 5B (FIG. 1C) of the inner retaining strap 5 up. One of the purse or handbag handles is placed roughly in the longitudinal center of the inner retaining strap in this position. The two ends of the inner retaining strap are wrapped around the circumference of the purse handle engaging the hook and loop material 4 (FIG. 1C) until it forms a closure. FIG. 2 shows the inner retaining strap 5 closed around one purse handle. The function of the inner retaining strap is to secure the invention to one of the purse handles so that during operation of securing or releasing the second purse handle there is less risk of the invention falling off the purse or handbag handle.

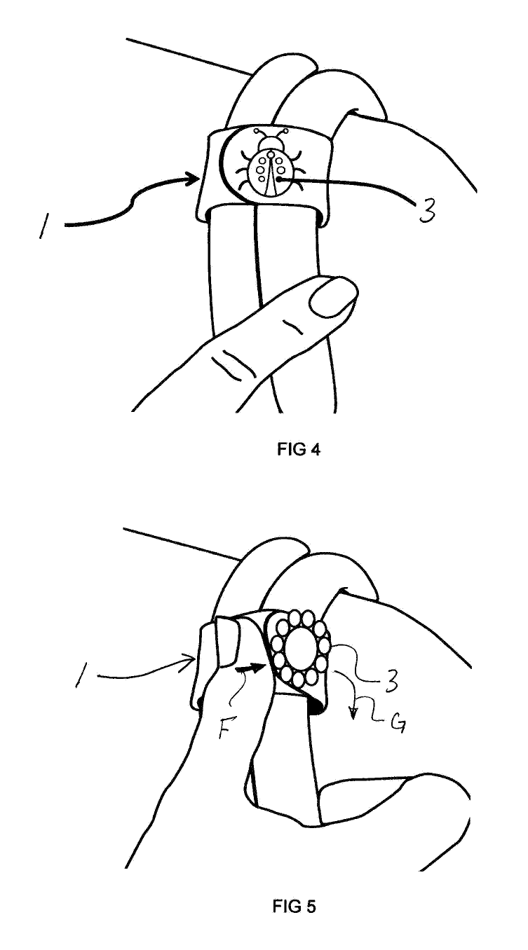

Once the inner retaining strap 5 is secured in the manner depicted in FIG. 2, the second purse or handbag handle is brought alongside the first and over the inner face 2B (FIG. 1B) of the outer retaining strap. FIG. 3 indicates how the two handles of the purse are brought next to each other, the user wraps the longitudinal ends of the outer retaining strap 1 (FIG. 1B) together engaging the hook and loop material 4, on the outer face 2A (FIG. 1B) with the hook and loop material on the inner face 2B (FIG. 1B) of the outer retaining strap effecting a full closure around both purse or handbag handles. The weight of the charm 3 assists in the closure. That is, if the two handles are brought together, one end of the outer retaining strap can be held by a finger or the hand against the purse handles, and the other put in motion by a simple flipping or sweeping action of the hand or finger in a direction for engaging or closing the associated closure, and the weight of the charm 3 will aid in engaging the closure. Thus, it can be envisioned that as an easy and convenient manner of operation, the device can be closed by holding the two handles together and with a simple and quick flipping or sweeping movement with a hand or finger against a free end of the outer retaining strap, imparting or exerting a force thereagainst as denoted by arrow F in FIG. 3, propelling that end toward the other end of that strap to engage the outer closure. This is particularly easily accomplished if the closure is a hook and loop fastener or magnetic.

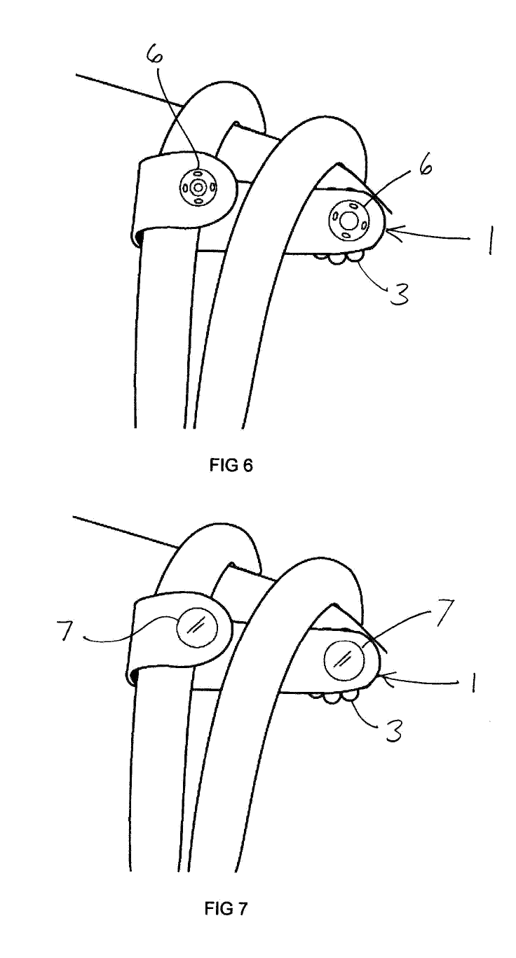

FIG. 4 shows a perspective view of the present invention in the fully closed position. The outer retaining strap 1 is fully enclosed around the purse handles and the decorative charm 3 is visible along the outer face of the outer retaining strap. FIG. 5 is a perspective view of the user opening the outer retaining strap in order to release one of the purse or handbag handles. To accomplish this is a simple procedure that can generally be done with one hand. The user can grasp the purse straps, e.g., with the fingertips and use the thumb to push against the end of the underside of the outer retaining strap including the decorative charm. A sufficient force, denoted by arrow F, exerted by a finger or a hand in the direction for disengaging the closure will disengage the closure connecting the ends of the outer retaining strap and the weight of the charm 3 will assist in the outer retaining strap falling under force of gravity as denoted by arrow G to an open position similar to that depicted in FIG. 3. This can be done with a quick flipping or sweeping action of the hand or finger to exert the force against the closure in the disengaging direction to disengage it, and this action can be imparted with a quick finger or hand movement against the now free end of the outer retaining strap such that gravity will act to move it in a downward direction away from the other end of that strap. One of the handles is now free to also fall under force of gravity away from the other handle, and this can be initiated with the same hand or finger action.

ALTERNATE EMBODIMENTS—In broad embodiment, the invention is a device for the purpose of holding the handles of a handbag or purse together. However, in any embodiment the apparatus allows the release of one purse or handbag handle while staying attached to the other; therefore reducing the risk of loss of the invention itself and without having to completely remove the invention in order to gain access to the interior of the handbag or purse by releasing one of the handles. Many variations of aspects of the invention will occur to those skilled in the art. Some variations include, color, closure methods, choice of materials, the type and design of various charms and decorative items. All such variations are intended to be within the scope and spirit of the invention.

Although some embodiments are shown to include certain features, the applicant(s) specifically contemplate that any feature disclosed herein may be used together or in combination with any other feature on any embodiment of the invention. It is also contemplated that any feature may be specifically excluded from any embodiment of an invention.

FIG. 1 shows an embodiment with a hook and loop closure; however, many other suitable closure embodiments may take form, such as a snap system, buckle, or magnet. FIG. 6 shows an alternative embodiment with a metallic or plastic snap closure mechanism. FIG. 7 shows an alternative embodiment with a magnetic closure. FIG. 4 and FIG. 5 depict varying charm elements 3.

What is claimed is:

1. A device for holding two handles of a purse or handbag together, comprising an inner strap configured to form a closable loop around one of the purse handles to secure the device to the purse, and an outer strap configured to form a closable loop around the inner retaining strap and another of the purse handles for securing the purse handles together.

2. The device for holding two handles of a purse or handbag together as recited in claim 1, wherein said inner retaining strap comprises an elongate element of a flexible material, generally inelastic in a longitudinal direction therealong.

3. The device for holding two handles of a purse or handbag together as recited in claim 1, wherein said inner retaining strap has an element of a closure on a first end thereof and on a second end thereof, respectively, the elements of the closure being engageable to form the closeable loop around said one of the purse handles.

4. The device of claim 3, wherein the elements of the closure comprise hook and loop fasteners.

5. The device for holding two handles of a purse or handbag together as recited in claim 1, wherein said outer retaining strap is an elongated flexible material, generally inelastic in a longitudinal direction therealong.

6. The device for holding two handles of a purse or handbag together recited in claim 1, in which said outer retaining strap has elements of a closure attached to a first end and a second end thereof, respectively, the elements being engageable to form the closable loop around said inner retaining strap and said another of the purse handles.

7. The device for holding two handles of a purse or handbag together as recited in claim 6, wherein the elements of the closure are selected from the group consisting of hook and loop fasteners, mechanical snaps, and magnets.

8. The device for holding two handles of a purse or handbag together as cited in claim 1, in which said outer retaining strap and said inner retraining strap are joined together by an attachment at or near overlaying longitudinal centers thereof, and the attachment has a length of not more than about 4 centimeters longitudinally in either direction from the longitudinal center of the said inner retaining strap to provide a supportable connection between the said inner and outer retaining straps while allowing for free and independent movement of longitudinal ends thereof.

9. The device for holding two handles of a purse or handbag together as recited in claim 1, wherein the outer retaining strap has an outer face including one or more decorative elements affixed at a longitudinal end thereof, providing a weight and being configured and positioned for grasping with fingers to open the outer retaining strap.

10. A method of holding two purse or handbag handles together comprising steps of:
a. providing a purse or handbag with two handles configured to be held together by a human hand;
b. providing a device to hold the two purse or handbag handles together, comprising an inner retaining strap and an outer retaining strap of flexible material with a releasable closure at longitudinal ends of each of the inner and outer retaining straps engageable for forming each of the retraining straps into a closed loop, respectively;
c. wrapping the inner retaining strap around a first of the purse handles and engaging the closure of the inner retaining strap forming a closed loop to secure the device to the first of the purse handles; and
d. placing a second of the purse handles alongside the first of the purse handles and wrapping the outer retaining strap around the inner retaining strap and the second of the purse handles, and engaging the closure of the outer retaining strap forming a loop around the inner retaining strap and the second of the purse handles.

11. The method of claim 10, wherein an end of the outer retaining strap includes a weight, and the step of engaging the closure of the outer retaining strap forming the loop around the inner retaining strap and the second of the purse handles, comprises imparting a force against the weight with a hand or finger action to move the end of the outer retaining strap in a direction to engage the closure thereof.

12. The method of claim 10, comprising a further step of opening the outer retaining strap by imparting a force against an end thereof or the weight to disengage the closure thereof.

13. The method of claim 12, wherein the step of imparting the force against the end of the outer retaining strap comprises movement thereagainst with a flipping or sweeping action of a hand or finger.
